(19) United States
(12) Patent Application Publication
(10) Pub. No.: US 2018/0266468 A1
(43) Pub. Date: Sep. 20, 2018

(54) COMPONENT, PROVIDED WITH A THREAD

(71) Applicant: Siemens Aktiengesellschaft, Munich (DE)

(72) Inventors: Peter Kury, Essen (DE); Dirk Hänsel, Werder (Havel) (DE); Marc Lange, Köln (DE)

(73) Assignee: Siemens Aktiengesellschaft, Munich (DE)

(21) Appl. No.: 15/762,677

(22) PCT Filed: Jul. 26, 2016
(86) PCT No.: PCT/EP2016/067718

§ 371 Date: Mar. 23, 2018

(30) Foreign Application Priority Data
Sep. 30, 2015 (EP) 15187631.5

(51) Int. Cl. F16B 33/02; F16B 31/06; F16B 31/04; F01D 25/16

(52) U.S. Cl. CPC F16B 33/02; F16B 31/06; F16B 2033/04; F01D 25/162; F16B 31/04

(57) ABSTRACT

A component, provided with a thread has increased play in the axial direction in comparison with a standard thread, which allows nuts to be screwed on, even in the case of highly preloaded bolts, and also enables a highly loadable threaded connection. For this purpose, the play is monotonically increasing in the axial direction.

### CROSS REFERENCE TO RELATED APPLICATIONS

This application is the US National Stage of International Application No. PCT/EP2016/067718 filed Jul. 26, 2016, and claims the benefit thereof. The International Application claims the benefit of European Application No. EP15187631 filed Sep. 30, 2015. All of the applications are incorporated by reference herein in their entirety.

### FIELD OF INVENTION

The invention relates to a component, provided with a thread, which has a greater play in the axial direction compared to a standard thread. It furthermore relates to a method for finishing a standard thread of a component, in which a greater play is introduced in the axial direction.

### BACKGROUND OF INVENTION

In various technical fields, bolts which are under a particularly high load are often stretched externally (e.g. hydraulically) in the axial direction, the nuts are turned with form fit in the stretched state and the external pre-tensioning force is then released so that the nuts assume the load in the axial direction. This method prevents torsional forces in the bolt and frictional wear in the threaded connection, which would be the case when a nut is actively rotated until reaching the desired pre-tension. In some applications, e.g. tie rods for stationary power-plant gas turbines, an active rotation of the nut would even be impossible for the reasons mentioned.

Typical elongations with such stretching in the axial direction are in the range of several per mil (relative elongation). Since conventional standard threads (this refers in particular to metric ISO standard threads [DIN 13 and DIN 14], threads according to Unified Thread Standard [ANSI/ASME B1.1-2003] or Whitworth threads) do not have an explicit axial play—this is instead only produced by the tolerance fields of the flank diameters—this low axial play is frequently used up completely when the bolt is under a load and subsequently elongated. It can thus become impossible to rotate nuts with standard threads on highly pre-tensioned bolts.

As a solution for this, it is proposed in EP 1 527 283 B1 to modify the thread form and, deviating from the standard thread form, to uncouple the axial and radial play or to widen the nut thread and thereby, in particular, introduce an additional axial play. However this can involve cost- and compatibility-related problems since special cutting tools have to be used; furthermore, the thread engagement and therefore the load-bearing capacity (resistance to stripping) are reduced.

### SUMMARY OF INVENTION

It is therefore the object of the invention to provide a component and a method of the type mentioned at the outset, which, on the one hand, enable nuts to be rotated even when the bolts are highly pre-tensioned and, on the other, also enable a screw connection with a high load-bearing capacity.

With regard to the component, this object is achieved according to the invention in that the play increases monotonically in the axial direction.

With regard to the method, the object is achieved in that the play is introduced such that it increases monotonically in the axial direction.

In this case, the invention starts with the consideration that easier rotation of the nut on a pre-tensioned bolt is then possible when the axial play increases in the axial direction according to the elongation of the bolt. However, since this still leaves regions with a low increase in the axial play, a high stability of the screw connection is still maintained.

To this end, the axial play increases linearly or is introduced in the method such that it increases linearly. This is advantageous since the deformation of the bolt during the elongation is distributed uniformly over its length.

According to the invention, it is provided here that the axially linearly increasing play increases over the entire axial length of the thread, i.e. the axial offset increases linearly over the entire axial length of the thread.

It is essentially possible here that each of the two thread partners, i.e. the internal or external thread, are provided with the described axially increasing axial play; both thread partners can also be finished accordingly. In a particularly advantageous embodiment, however, the finished component which is finished with an axially increasing play is formed as a nut whilst the bolt to be stretched during the rotation is formed as a conventional standard thread.

In an advantageous embodiment of the method, the play is introduced by means of a standard cutting tool. This simplifies the finishing process considerably.

A play in the radial direction is furthermore advantageously additionally introduced proportionally to the play in the axial direction. This can also be realized in a simple manner by means of a standard cutting tool and increases the ease of movement when rotating the nut.

A nut described above is advantageously used in a method for screwing the nut onto a bolt, wherein, before screwing on the nut, the bolt is mechanically stretched by a predetermined relative elongation and wherein the maximally introduced axial play corresponds to the product of the relative elongation and the axial height of the thread. It is thus ensured that the introduced axial play is sufficient to enable a rotation of the nut on the bolt to be carried out without jamming.

The bolt here is advantageously part of a tie rod of a gas turbine. Particularly in the case of gas turbines, the tie rod is namely that which secures the shaft of the rotor of the gas turbine, elongated in the manner described, before it is secured by a nut.

The advantages achieved by the invention consist in particular in that, by finishing a standard thread with an axially increasing axial play, a simple rotation on a stretched bolt is enabled on the one hand and a particularly good load-bearing capacity of the screw connection produced is still ensured on the other.

### BRIEF DESCRIPTION OF THE DRAWINGS

Exemplary embodiments of the invention are explained in more detail with reference to drawings, which show:

FIG. 1 a schematic cross-section of a screw connection of two standard threads according to the prior art;

FIG. 2 the maximum possible elongation of the bolt of the screw connection according to the prior art;

FIG. 3 the maximum possible elongation of the bolt of a screw connection with the axial play in the thread of the nut increasing in the axial direction;

FIG. 4 clarification of the linearly increasing axial finishing process of the example of FIG. 3;

FIG. 5 clarification of the linearly increasing axial finishing of both thread partners in a schematic longitudinal section of a screw connection;

FIG. 6 a schematic longitudinal section through a screw connection with a proportional axial and radial finishing of the nut;

FIG. 7 a schematic longitudinal section through a screw connection with a proportional axial and radial finishing of both thread partners;

FIG. 8 a schematic longitudinal section through a thread with clarification of the variables used in the graphs shown in the following illustrations;

FIG. 9 graphs of the axial linearly increasing play plotted against the axial position;

FIGS. 10-13 graphs of possible further embodiments for an axial play plotted against the axial position; and

FIG. 14 a graph of the load/load-bearing capacity of the thread relative to the axial position.

The same parts are denoted by the same reference signs in all figures.

### DETAILED DESCRIPTION OF INVENTION

FIG. 1 shows a schematic partial longitudinal section through the upper part of a screw connection. The profiles of both thread partners are shown, namely a nut 1 and a bolt 2. The thread 4 of the nut 1 and the thread 6 are constructed as standard, i.e. as a metric ISO standard thread (DIN 13 and DIN 14), as threads according to Unified Thread Standard (ANSI/ASME B1.1-2003) or as Whitworth threads. In any case, an explicit case Δxmin is not provided in such threads 4, 6. Instead, the axial play Δxmin is merely produced by the manufacturing-related tolerance zones of the flank diameters. The arrows 8, 10 show the load directions of the nut 1 and bolt 2.

The nuts 1 and bolts 2 described here are provided for a particularly high load. In exemplary embodiments, the bolt 2 can be arranged for example at the end of the shaft of a gas turbine (not shown in more detail) such that it is coaxial to said shaft and can secure the shaft and the turbine wheels in the form of a tie rod. To this end, the bolt 2 is firstly stretched externally, e.g. hydraulically, the nut 1 is then rotated with form fit in the stretched state and the pre-tensioning force is subsequently released so that the nut 1 assumes the load.

FIG. 2 shows the screw connection of FIG. 1 and, in addition, a grid view 12 of the bolt 2 in the stretched state. The grid view 12 shows the maximum possible elongation of the bolt 2 so that the nut 1 is still rotatable with the existing axial play Δxmin. Greater elongations would result in the nut 1 no longer being actively rotatable or in jamming occurring.

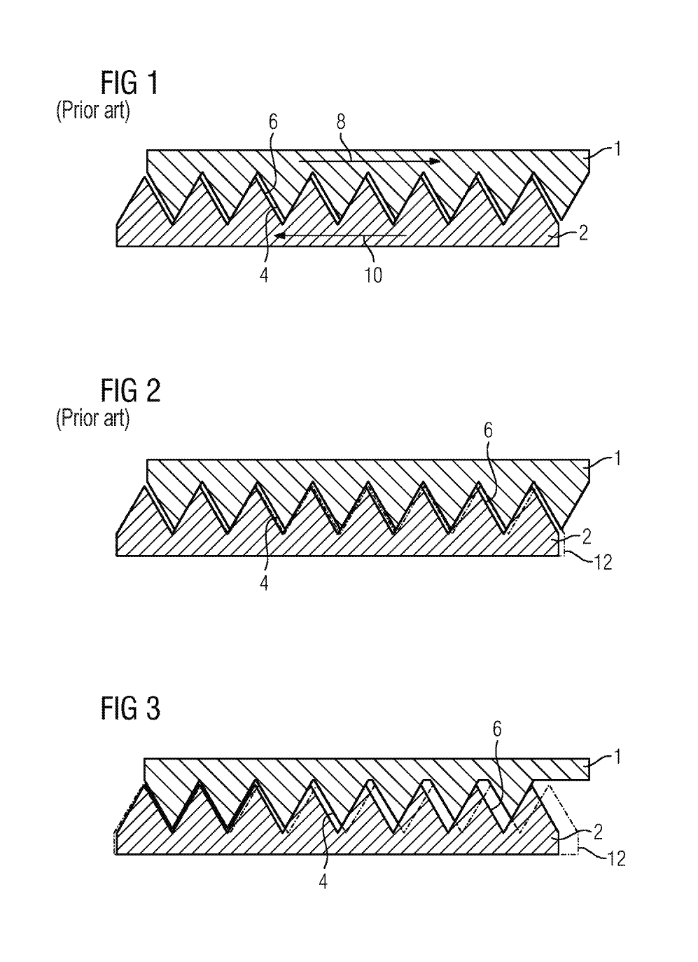

FIG. 3 now shows the screw connection of FIGS. 1 and 2, which has, however, undergone a finishing process. By means of a standard thread cutting tool, an additional axial play has been introduced into the thread 4 of the nut 1 here. In this case, the axial play increases from left to right in FIG. 3., i.e., during the finishing process, the cutting tool has been moved continuously further to the right in the axial direction from the standard position. This enlarges the axial play in a monotonically increasing manner in the thread 4 of the nut 1. Since the flank angle is not altered, due to the use of the standard thread cutting tool, this also results in a radially increasing offset, i.e. the height of the profile of the thread 4 reduces continuously from left to right.

FIG. 3 also shows a grid view 12 of the bolt 2, which shows the maximum possible elongation of the bolt 2 so that the nut 1 with the existing axial play Δxmin is still rotatable. FIG. 3 clearly shows that a considerably greater elongation of the bolt 2 is enabled due to the finishing process.

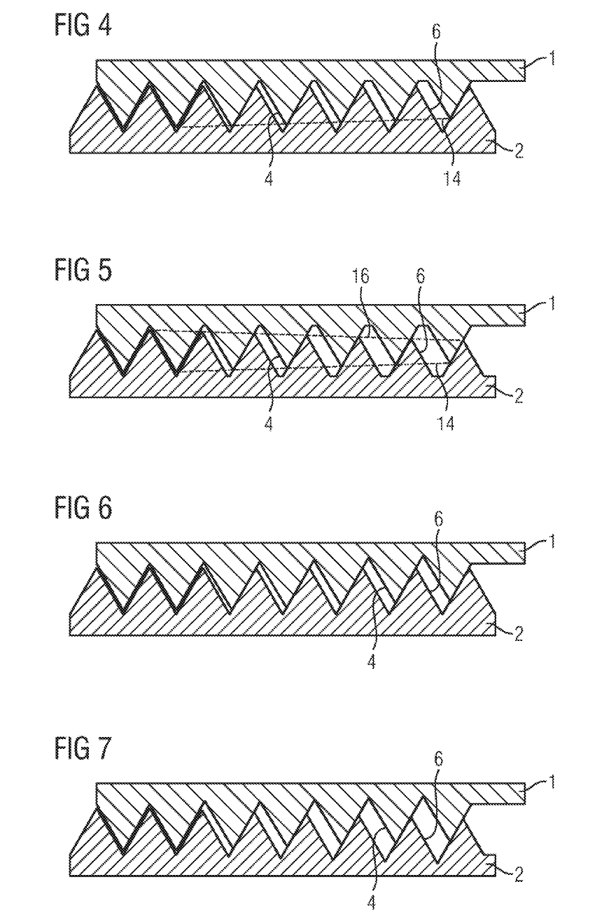

FIG. 4 shows the screw connection of FIG. 3, although the tips of the profile of the thread 4 of the nut 1 are connected to one another here by a dashed line 14. FIG. 4 shows that the first two thread turns (on the left in the drawing) are not modified; the finishing process is only initiated after this. This takes place with a linearly increasing greater axial play, which is shown as a straight line by the progression of the line 14.

FIG. 5 shows a further variant in which the two threads 4, 6 of the nut 1 and bolt 2 are finished in the same manner here. The thread 4 of the nut 1 is finished precisely as illustrated in FIGS. 3 and 4, whilst the bolt 2 is likewise finished by means of the standard thread cutting tool. The right flanks of the thread 6 in each case are finished in the same manner, i.e. with a linearly increasing axial play (illustrated by the line 14) after the first two thread turns.

FIG. 6 and FIG. 7 show variants of the exemplary embodiments of FIG. 4 and FIG. 5. In contrast to the latter exemplary embodiments, the cutting tool here has not only been displaced axially, but also axially into the profile of the thread 4 of the nut 1 (FIG. 6) or into the profile of both threads 4, 6. A radial play is thereby also introduced into the respective thread 4, 6 in equal measure, i.e. proportionally to the introduced axial play.

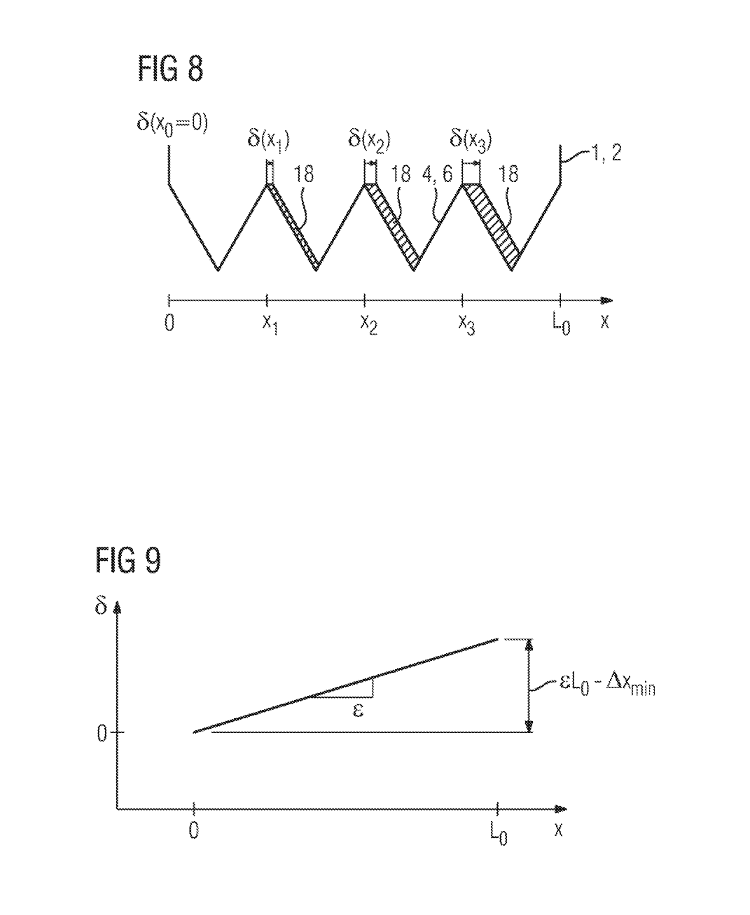

The progression of the introduced additional play is explained with reference to the following FIGS. 8 and 9.

FIG. 8 explains the variables used in the graphs of FIG. 9. FIG. 8 shows, in the upper region, the thread 4, 6 of the nut 1 or bolt 2, depending on the exemplary embodiment, and, in the lower region, an X-axis of a graph which shows the axial position x. The origin here is located at the axial start of the thread 4, 6; the axial height of the thread 4, 6 is denoted by L0. The periodic axial positions of the incisions between threaded flanks are shown on the X-axis by x1, x2, x3 . . . .

The axial offset, i.e. the additional axial play (in other exemplary embodiments, such as those referring to FIGS. 6 and 7, the additional radial play is also mentioned) is denoted by δ(x) according to the axial position x. FIG. 8 shows this by way of example for an approximately linear progression of the play δ(x); only an additional axial play δ(x) is introduced here. Those regions 18 of the thread flanks which are thus cut away are shown shaded. In all the exemplary embodiments illustrated below, which show the progressions of the play δ(x), the condition for L0: δ(L0)−δ(0)+Δxmin≥L0×ε applies, where ε is the relative elongation of the bolt 2 during the assembly of the nut 1, which is generally in the range of several per mil. Easy rotation of the nut 1 on the elongated bolt is thus ensured.

In this regard, FIG. 9 shows the progression of the play δ(x). This is shown in in the graph, in which the introduced additional play δ(x) deviating from the standard is plotted against the axial position x. In this case, δ(0)=0, δ(LO)=L0×ε (or alternatively δ(L0)=L0×ε−Δxmin) applies. The additional play L0 introduced over the entire length L0 is therefore sufficient to compensate the elongation of the bolt 2.

The progression of the play δ(x) in the exemplary embodiment according to FIG. 9 is linear between the already mentioned extreme values over the entire axial length, i.e. it has a pitch of ε. This is the simplest case of the finishing process.

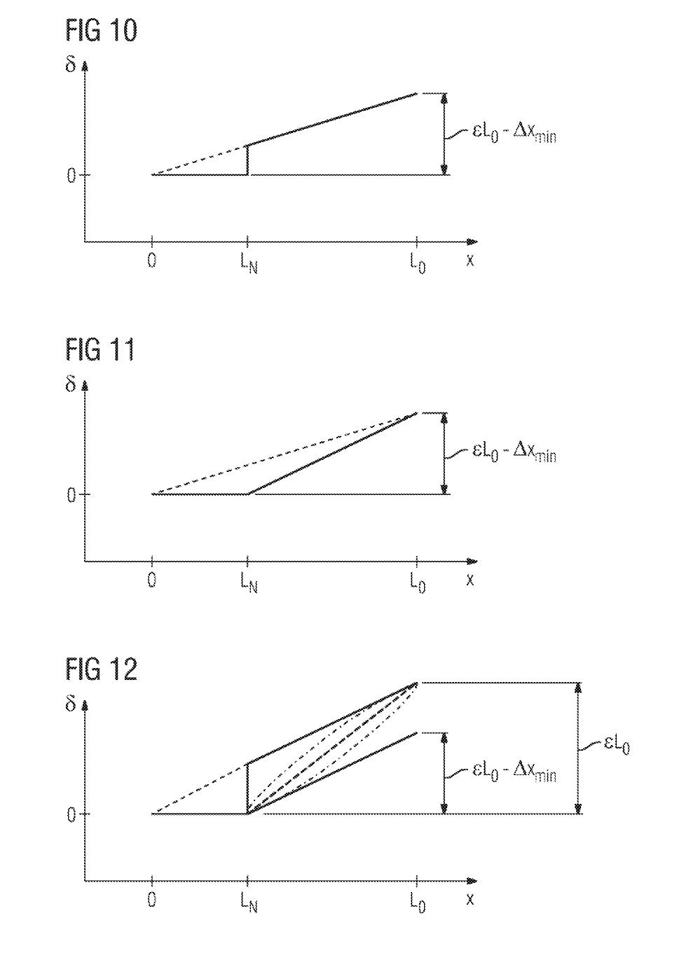

It is likewise possible, in the front region of the thread 4, 6, to provide no axial offset over a certain initial length LN. This can advantageously be a length over which jamming is not yet able to occur due to the axial play Δxmin which is also already present in a standard thread, even when the bolt 2 is stretched, i.e. LN≤Δxmin/ε applies. Such exemplary embodiments are shown in FIGS. 10-12. In all exemplary embodiments in FIGS. 10-12, therefore, δ(x)=0 in the region x≤LN, i.e. the thread 4, 6 corresponds to the standard thread here.

Depending on whether the value is based on the greatest possible load-bearing capacity or the maximum ease of movement or low jamming risk, the axial offset after the initial length LN can either be increased directly to the value required for the linear increase (shown in FIG. 10, δ(x)=ε×x applies for LN<x≤L0), or increased linearly continuously to the desired end value (shown in FIG. 11, δ(x)=L0×ε×(x−LN)/(L0−LN) applies for LN<x≤L0).

Since it is also optionally possible to take the initial axial play into account for the end value δ(L0) (see above, δ(L0)=L0xε or alternatively δ(L0)=L0×ε−Δxmin), there are four possible thread finishing processes for the combination of a linearly increasing correction δ(x) and a neutral initial length LN. The extreme cases here are the abrupt change from δ(x) for x>LN to the pitch ε up to the length L0, where δ(L0)=L0×ε, and the steady transition from δ(x) for x>LN to the pitch ε up to the length L0, where δ(L0)=L0×ε−Δxmin. Both progressions of the play δ(x) are shown in FIG. 12. All progressions therebetween (illustrated by dashed lines) are possible; values for the additional axial play δ(x) which are lower than the lower limit result in a tight fit of the nut and higher values than those specified by the upper limit weaken the thread structurally to a greater extent than is necessary.

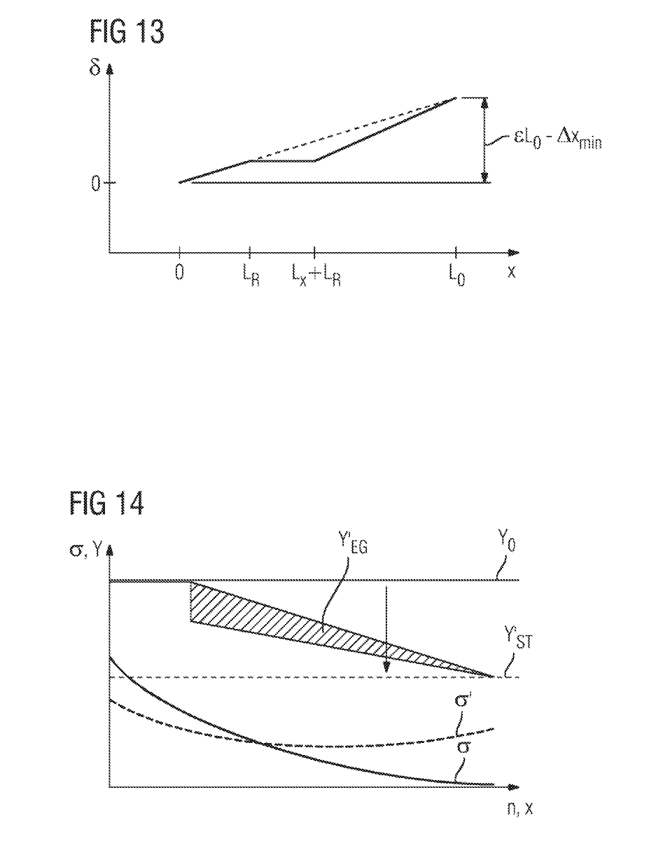

FIG. 13 shows a further possible progression of the additional axial play δ(x), which can be useful in the case of elastically load-optimized nuts. Such nuts are for example the Thumsche nut, which is known by the person skilled in the art from Illgner, K. H., Blume D.: Schrauben Vademecum; published by Bauer & Schaurte Karcher GmbH, 5^{th} edition 1983, Flexnuts by the company Nord-Lock. In the case of such nuts 1, in addition to the previously described exclusive finishing of the non-supporting flank of the nut 1 and/or bolt 2, finishing of the supporting flank can also be useful.

Since, at a specified axial position x, only either a modification of the supporting flank or a modification of the non-supporting flank takes place, the modification of the supporting flank is denoted by negative values of δ(x) in the graphs according to FIG. 13. In the embodiment for a finishing process for increasing the axial play δ(x) according to FIG. 13 for elastically load-optimized nuts 1, finishing of the supporting flank (negative value of δ(x)) with the pitch ε firstly takes place in the initial region from the length 0 to the length LR of the nut 1. In a region adjoining this, with a steady transition, there is no finishing process for LR<x<LX+LR, i.e. δ(x)=0. Only following this, for x>LX+LR, does the linear increase already explained with reference to FIG. 11 take place with a steady transition to the desired end value.

FIG. 14 finally shows that the finishing, described here, of the thread does not reduce its load-bearing capacity. FIG. 14 shows a graph which shows the typical load σ(x) on a thread 4, 6 along its axis (i.e. depending on the thread turns n or the axial position x), c.f. definition in Ch. J. Mech. Eng. 22(6), 869ff. (2009). The yield point Y of the nut material has to be selected such that it is still durable at the start of the thread (x=0), possibly with slight plasticization. A radial widening of the nut 1 reduces the effective load-bearing capacity Y′ST (the resistance to stripping is approximately proportional to the engagement), which means that this can be exceeded in the front region of the nut 1.

The finishing process described above shows this effect on the load-bearing capacity Y′EG only in the slightly loaded rear region of the nut 1. The monotonically increasing finishing described above is always better than a gross widening of the nut 1, even for load-optimized elastic nuts (see above) with more moderate stress curves σ′(x).

1. A component, comprising:
a thread which has a greater monotonically increasing play (δ) in the axial direction compared to a standard thread,
wherein the play (δ) increases linearly over the entire axial length of the thread.

2. The component as claimed in claim 1,
wherein the component is formed as a nut.

3. A method for finishing a standard thread of a component, in which a greater monotonically increasing play (δ) is introduced in the axial direction, comprising:
introducing the play (δ) such that it increases linearly over the entire axial length of the thread.

4. The method as claimed in claim 3,
wherein the component is formed as a nut.

5. The method as claimed in claim 3,
wherein the play (δ) is introduced by means of a standard cutting tool.

6. The method as claimed in claim 5, further comprising:
additionally introducing a play (δ) in the radial direction proportionally to the play (δ) in the axial direction.

7. A method for screwing a nut as claimed in claim 2 onto a bolt, comprising:
mechanically stretching the bolt by a predetermined relative elongation (ε) before the nut is screwed on, and
wherein the maximally introduced axial play (δ(L0)) corresponds to the product of the relative elongation (ε) and the axial height (L0) of the thread.

8. The method as claimed in claim 7,
wherein the bolt is part of a tie rod of a gas turbine.

9. The method as claimed in claim 7,
wherein a standard thread of the nut, is finished such that a greater monotonically increasing play (δ) is introduced in the axial direction, and
wherein the play (δ) is introduced such that it increases linearly over the entire axial length of the thread.

10. The method as claimed in claim 7, further comprising:
additionally introducing a play (δ) in the radial direction proportionally to the play (δ) in the axial direction.
